(19) United States
(12) Patent Application Publication
(10) Pub. No.: US 2019/0238556 A1
(43) Pub. Date: Aug. 1, 2019

(54) DRONE CAPABLE OF AUTONOMOUSLY DETERMINING TRUSTWORTHINESS OF MESSAGES RECEIVED

(71) Applicant: Walmart Apollo, LLC, Bentonville, AR (US)

(72) Inventors: David C. Winkle, Bella Vista, AR (US); Donald R. High, Noel, MO (US); John J. O'Brien, Farmington, AR (US)

(21) Appl. No.: 16/257,358

(22) Filed: Jan. 25, 2019

Related U.S. Application Data
(60) Provisional application No. 62/623,749, filed on Jan. 30, 2018.

(51) Int. Cl. H04L 29/06; B64C 39/02; H04W 4/12; H04L 9/32

(52) U.S. Cl. CPC H04L 63/123; B64C 39/024; B64C 2201/141; H04L 9/32; H04W 4/12

(57) ABSTRACT

In some embodiments, apparatuses and methods are provided herein useful to autonomously determining trustworthiness of a message. In some embodiments, a drone capable of autonomously determining trustworthiness of messages comprises a drone body, a propulsion mechanism, a plurality of sensors, a wireless radio, and a control circuit, wherein the control circuit is configured to receive, from the wireless radio, a message, determine a source transmitting the message, determine content of the message, determine, based on the source transmitting the message, the content of the message, and the observational data, contextual information for the message, determine, based on the contextual information for the message, an expectation for the message, and one of: determine, based on the contextual information and the expectation, that the message is trustworthy, and determine, based on the contextual information and the expectation, that the message is not trustworthy.

### CROSS-REFERENCE TO RELATED APPLICATION

This application claims the benefit of U.S. Provisional Application No. 62/623,749, filed Jan. 30, 2018, which is incorporated by reference in its entirety herein.

### TECHNICAL FIELD

This invention relates generally to message transmission and, more particularly, to message transmission to a drone.

### BACKGROUND

Autonomous vehicles (i.e., drones) are becoming more and more common. These autonomous vehicles can be used for a variety of purposes, such as surveillance, delivery, task performance, etc. As autonomous vehicles become more ubiquitous, the incidence of people with malicious intent attempting to interfere with autonomous vehicles is increasing. One method of preventing this is by use of cryptography to secure messages and identify senders (i.e., sources of messages). While securing messages and authenticating senders reduces the risk of an autonomous vehicle taking action in response to a message having malicious intent, these systems are vulnerable. For example, cryptography can be broken and senders can be impersonated. Consequently, a need exists for additional security measures to help prevent autonomous vehicles from taking action in response to messages having malicious intent.

### BRIEF DESCRIPTION OF THE DRAWINGS

Disclosed herein are embodiments of systems, apparatuses, and methods pertaining to a drone capable of autonomously determining trustworthiness of messages received by the drone. This description includes drawings, wherein:

FIGS. 1A and 1B are perspective views of a drone 100, according to some embodiments;

FIG. 2 is a block diagram of a drone 202, according to some embodiments; and

FIG. 3 is a flow chart depicting example operations for autonomously determining trustworthiness of a message received by a drone, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to a drone capable of autonomously determining trustworthiness of messages received by the drone. In some embodiments, a drone capable of autonomously determining trustworthiness of messages received by the drone comprises a drone body, a propulsion mechanism, wherein the propulsion mechanism is configured to self-propel the drone in a self-controlled manner, a plurality of sensors, wherein the plurality of sensors is configured to detect observational data for the drone, a wireless radio, wherein the wireless radio is configured to receive and transmit messages, and a control circuit, wherein the control circuit is communicatively coupled to the plurality of sensors and the wireless radio, and wherein the control circuit is configured to receive, from the wireless radio, a message, wherein the message includes identifying information regarding a source transmitting the message, determine, based on the identifying information, the source transmitting the message, determine, based on the message, content of the message, determine, based on the source transmitting the message, the content of the message, and the observational data, contextual information for the message, determine, based on the contextual information for the message, an expectation for the message, and one of: determine, based on the contextual information for the message and the expectation for the message, that the message is trustworthy and allow action to be taken by the drone in response to the determination that the message is trustworthy, and determine, based on the contextual information for the message and the expectation for the message, that the message is not trustworthy and refuse to allow action to be taken by the drone in response to the determination that the message is not trustworthy.

As previously discussed, drone usage is becoming more prevalent. Regardless of the specific use case, ensuring that a drone is not vulnerable to malicious messages is important. A first line of defense against malicious messages is authenticating a source of a message. This can be done by verifying the identity of the source and/or encrypting messages. Unfortunately, this first line of defense can be compromised. For example, a source of a message can be spoofed and encryption can be broken. If either of these vulnerabilities are exploited, the drone may believe that a malicious message should be followed simply because the source of the messages appears to be legitimate.

Embodiments of the systems, methods, and apparatuses described herein seek to provide enhanced security by autonomously evaluating the context surrounding a message (i.e., contextual information for a message) against an expectation for a message. Quite simply, embodiments described herein allow a drone to perform a complex evaluation, much like a person would.

For example, when a person deliveries packages, the person is able to evaluate the context around which messages are received. That is, if the delivery person receives a message (e.g., updated delivery instructions, new route information, weather information, etc.), the delivery person can evaluate contextual information for the message as well as an expectation for the message to make a determination as to whether the message is trustworthy.

As one example, if the message includes updated delivery instructions and the updated delivery instructions request that the delivery person deliver a package at a later time than originally scheduled, the delivery person can evaluate the context of the message (e.g., based on a source of the message, content of the message, and observational data) against an expectation for the message. If the delivery person determines that the package will be delivered to the same address, but only at a later time, and that it isn't uncommon for this customer to request late deliveries, the delivery person may conclude that the contextual information for the message matches the expectation for the message. Because the contextual information for the message matched the expectation for the message, the delivery person can determine that the message (i.e., the new delivery instructions) is trustworthy and that the message should be adhered to. However, if the message includes updated delivery instructions and the updated delivery instructions request that the delivery person deliver all packages to a new, unknown address, and the message originated from an unknown source, the delivery person may determine that the message is not trustworthy and should not be adhered to.

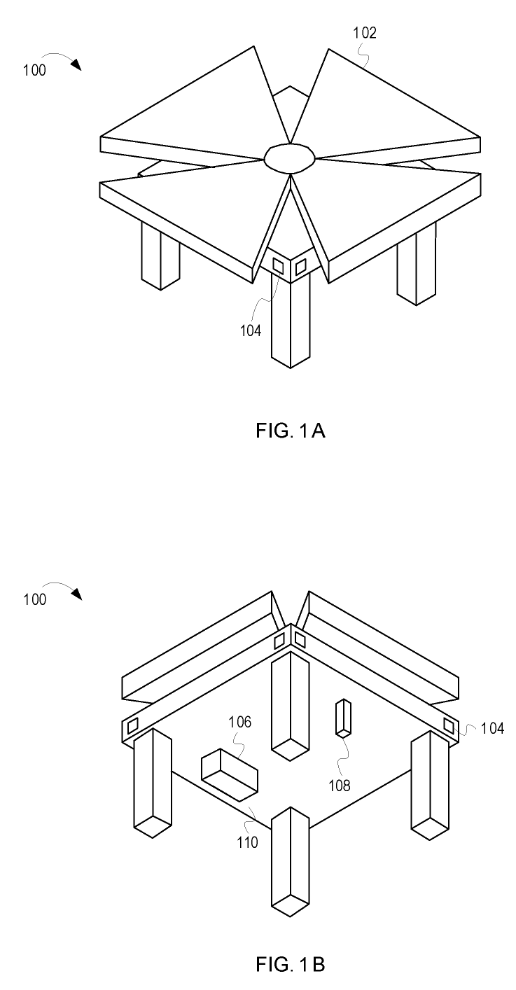

Embodiments described herein include a drone capable of making a determination as to the trust worthiness of a message autonomously. In some embodiments, the drone determines contextual information for the message (e.g., based on a source of the message, observational data, and content of the message), determines an expectation for the message, and performs an evaluation of the contextual information for the message and the expectation for the message to determine if the message is trustworthy. The discussion of FIGS. 1A and 1B provide an overview of such a drone.

FIGS. 1A and 1B are perspective views of a drone 100, according to some embodiments. Although depicted in FIGS. 1A and 1B as an aerial drone, the drone 100 can be of any suitable type (e.g., terrestrial, aquatic, aerial, or any combination of the three). The drone 100 includes a drone body 110, a propulsion mechanism 102, a plurality of sensors 104, a wireless radio 108, and a control circuit 106. In some embodiments, the drone 100 is capable of travelling autonomously. That is, the drone 100 is configured to self-propel in a self-controlled manner.

The drone 100 can be configured and/or equipped for any number of tasks. As one example, the drone 100 can be configured and/or equipped to operate as a delivery drone. In such an embodiment, the drone 100 can delivery packages to customers. Prior to, during, and after delivering packages, the drone 100 can receive messages. These messages can be received from any number of sources, such as other drones, backend systems, customers, etc. The messages can also have a variety of content, such as information, instructions, commands, and advisories.

When the drone 100 receives a message, the drone 100 evaluates the message to determine whether the message is trustworthy. If the message is trustworthy, the drone 100 allows action to be taken by the drone 100 in response to the message. If the message is not trustworthy, the drone 100 can refuse to allow action to be taken by the drone 100 in response to the message. In some embodiments, evaluation of the message comprises determining contextual information for the message and an expectation for the message. If the contextual information for the message matches the expectation for the message, the message is trustworthy. If the contextual information for the message does not match the expectation for the message, the message is not trustworthy.

The drone 100 can consider any number of factors when determining contextual information for the message. In some embodiments, the drone 100 considers a source transmitting a message, content of the message, and observational data when determining the contextual information for the message.

The drone 100 can determine the source transmitting the message based on identifying information contained in the message. The identifying information can identify the source transmitting the message either explicitly or implicitly. For example, the identifying information can include a data field with an indicator of the source of the message, or the identifying information can be the sum of multiple pieces of information from which the drone 100 can determine the source transmitting the message. In some embodiments, the identifying information can include cryptography, such as by way of a public and private key or information stored via blockchain. In such embodiments, the drone 100 can cryptographically verify the source transmitting the message.

The drone 100 can also consider the content of the message when determining the contextual information. The content of the message can be informational, instructional, advisory, etc. For example, a message including updated delivery information and weather information would be both instructional and informational. The content of the message can also be specific as to an instruction included in the message. For example, if the message includes an instruction to return to a distribution facility to retrieve additional packages, the content of the message would include the retrieval instruction.

The drone 100 can also make assessments based on observational data obtained via the sensors 104. The observational data can include the drone's 100 direction of travel, the drone's 100 speed, the drone's 100 altitude, weather conditions, the presence of objects near the drone 100, electromagnetic energy (e.g., radiofrequency signals) near the drone 100, etc. Accordingly, the sensors 104 can be any type of sensor that is suitable to detect the observational data. For example, the sensors 104 can include radar sensors, temperature sensors, time sensors (e.g., a clock), power sensors, sound sensors, reservoir level sensors, weight sensors, location sensors (e.g., GPS transceivers), altitude sensors (e.g., altimeters), gyroscopes, pressure sensors, humidity sensors, moisture sensors, accelerometers, etc.

The contextual information for the message provides the drone 100 with many data points regarding the message. The contextual information for the message allows the drone 100 to determine an expectation for the message in a holistic manner. That is, the drone's 100 expectation for the message is based on the multiple factors that make up the contextual information. The expectation for the message can be related to an expected sender (i.e., source transmitting the message), an expected content, a reasonableness of instruction (i.e., the reasonableness of an instruction included in the message), an expected communication protocol, an expected time (e.g., whether the message is received at a time that is expected or whether the message instructs the drone to do something at a time that is expected), expected context of the message, expected safety resulting from adherence to the message (e.g., the drone's 100 safety, safety to other drones, safety to cargo carried by the drone 100, safety to living creatures, etc.), an expected communication, etc.

As a first example, if the message includes an instruction to deliver a package, the delivery location is associated with a known delivery recipient, the source transmitting the message is a known source, the package delivery is scheduled for a reasonable time (e.g., during business hours), and the current weather conditions permit such a delivery at the delivery location, the expectation for the message is a new delivery instruction. That is, based on the source transmitting the message, the content of the message, and the observational data (i.e., the contextual information for the message), the drone 100 expects to receive a message including new delivery instructions.

As a second example, if the source transmitting the message appears to be a known source, the message includes an instruction to deliver a package to an unknown delivery location, and the new package delivery instructions are for a time is not reasonable (e.g., alter the drone's 100 route to deliver the package immediately), the drone's 100 expectation for the message may not match the contextual information for the message. That is, the drone 100 may not expect to receive a message that instructs the drone 100 to alter its route and deliver a package immediately to an unknown address.

After determining the contextual information for the message and the expectation for the message, the drone analyzes the message for trustworthiness. In some embodiments, the drone determines trustworthiness of the message based on the contextual information for the message and the expectation for the message. For example, the drone 100 can compare the contextual information for the message and the expectation for the message. In the first example described above, the contextual information for the message matched the drone's 100 expectation for the message. That is, the message was received from a known source and included an instruction to deliver the package that was reasonable (i.e., the delivery location was associated with a known delivery recipient, the timing for the delivery was reasonable, and the weather conditions permitted the delivery), so the contextual information for the message matched the drone's 100 expectation for the message. Because the contextual information for the message matched the drone's 100 expectation for the message, the drone 100 can determine that the message is trustworthy. If the drone 100 deems the message trustworthy, the drone 100 can allow action to be taken by the drone 100 in response to the message. In the first example described above, the drone 100 would deliver the package to the delivery location.

In the second example described above, the contextual information for the message did not match the drone's 100 expectation for the message. That is, although the message appeared to have been transmitted from a known source, the message included an instruction to deliver the package to an unknown delivery location (e.g., a new delivery location or a delivery location that is not associated with a known delivery recipient), and the message included an instruction for the drone 100 to alter its route and deliver the package immediately, the contextual information did not match the drone's 100 expectation for the message. For example, the drone 100 may not expect to receive an instruction to deliver a package to an unknown address and/or to alter its route to deliver a package immediately. Because the contextual information for the message did not match the drone's 100 expectation for the message, the drone 100 may determine that the message is not trustworthy. If the drone 100 determines that the message is not trustworthy, the drone 100 can refuse to allow action be taken by the drone 100 in response to the message. In the second example described above, the drone 100 can refuse to deliver the package to the unknown delivery location. In some embodiments, after the drone 100 determines that the message is not trustworthy, the drone 100 can flag the source transmitting the message as not trustworthy. For example, the drone 100 can flag the source transmitting the message as not trustworthy in a database resident on the drone 100 and/or transmit a notification, for example to a backend server and/or other drones, to flag the source transmitting the message as not trustworthy.

In some embodiments, as another form of security, upon receipt of the message, the drone 100 can generate and transmit a response. The drone 100 can send this response to the source transmitting the message and/or a backend server for verification. To further enhance security, the drone 100 can transmit the response via a different communication protocol. For example, if the drone 100 receives the message via a wireless wide area network (WWAN) protocol, the drone 100 can transmit the response via a radio frequency modulation protocol.

In some embodiments, the determination that the message is or is not trustworthy can be based on a threshold number of parameters (e.g., the source transmitting the message, the content of the message, the observational data, etc.) not matching the drone's 100 expectation. For example, if the message is from a known source and the content of the message matches the drone's 100 expectation, the drone 100 may still deem the message trustworthy even if the weather information observed by the sensors 104 indicates that the delivery may be difficult. Additionally, or alternatively, in some embodiments, certain parameters must match the drone's 100 expectation to be deemed trustworthy. For example, even if the content of the message and the observational data for the message meet the drone's 100 expectation, the drone 100 may deem the message as not trustworthy if the source transmitting the message is not known or cannot be verified.

In some embodiments, the drone 100 can travel in a group comprising other drones (i.e., other members of the group). In such embodiments, the drone 100 (or any of the other drones) can act as a leader of the group. As the leader, the drone 100 can be responsible for determining the trustworthiness of messages for all drones in the group. In one embodiment, the drone 100 as the leader acts to receive messages for all or a portion of the drones in the group. That is, any message that is to be sent to one of the drones in the group or portion of the group is sent to the drone 100 acting as the leader. The drone 100 determines trustworthiness of the messages and reroutes or relays the messages to appropriate ones of the drones. For example, if the drone 100 determines that the message is trustworthy, the drone 100 transmits the message to the intended recipient of the message. If the drone 100 determines that the message is not trustworthy, the drone 100 can either transmit the message to the intended recipient of the message with a notification that the message is not trustworthy, or simply transmit the notification that a message was received for the intended recipient that was not trustworthy. In another embodiment, all drones in the group transmit received messages to the drone 100 acting as the leader. In such embodiments, the drone 100 acting as the leader determines whether the message is trustworthy. If the message is trustworthy, the drone 100 transmits a notification back to the drone from which the message was received indicating that the message is trustworthy. If the message is not trustworthy, the drone 100 transmits a notification back to the drone from which the message was received indicating that the message is not trustworthy.

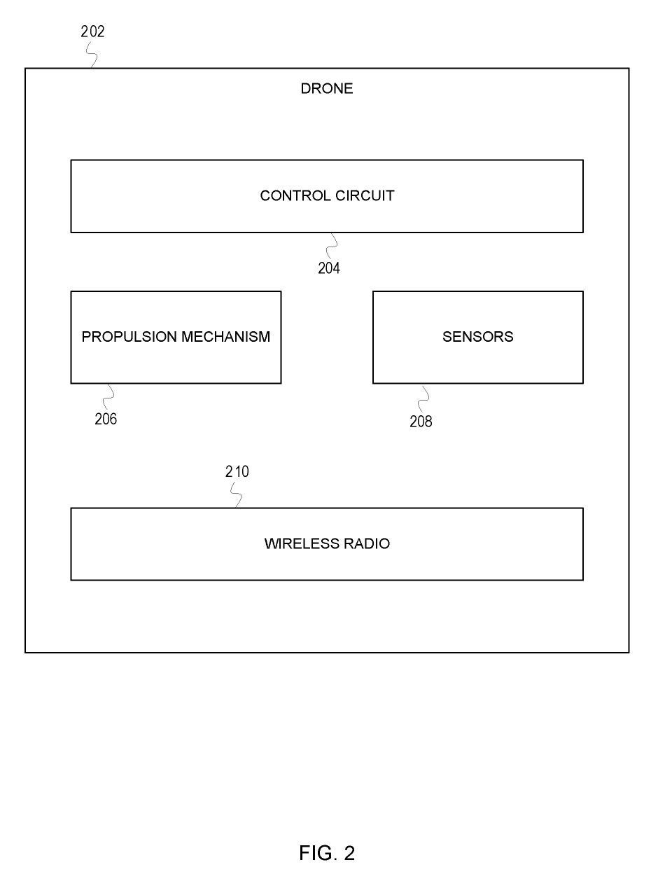

While the discussion of FIGS. 1A and 1B provide an overview of a drone capable of autonomously determining trustworthiness of a message, the discussion of FIG. 2 provides additional detail regarding such a drone.

FIG. 2 is a block diagram of a drone 202, according to some embodiments. The drone 202 includes a control circuit 204, a propulsion mechanism 206, sensors 208, and a wireless radio 210. The propulsion mechanism 206, sensors 208, and wireless radio 210 are communicatively coupled to the control circuit 204. The control circuit 204 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 204 is configured (for example, by using corresponding programming as will be well understood by those skilled in the art) to carry out one or more of the steps, actions, and/or functions described herein.

By one optional approach the control circuit 204 operably couples to a memory. The memory may be integral to the control circuit 204 or can be physically discrete (in whole or in part) from the control circuit 204 as desired. This memory can also be local with respect to the control circuit 204 (where, for example, both share a common circuit board, chassis, power supply, and/or housing) or can be partially or wholly remote with respect to the control circuit 204 (where, for example, the memory is physically located in another facility, metropolitan area, or even country as compared to the control circuit 204).

This memory can serve, for example, to non-transitorily store the computer instructions that, when executed by the control circuit 204, cause the control circuit 204 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The propulsion mechanism 206 propels the drone 202. The propulsion mechanism 206 can be of any suitable type dependent upon the type of the drone 202. For example, the propulsion mechanism 206 for an aerial drone may include one or more propellers and one or more motors, whereas the propulsion mechanism 206 for a terrestrial drone may include an engine or motor and transmission. The propulsion mechanism 206 is configured to self-propel the drone in a self-controlled manner.

The control circuit 204 determines trustworthiness of messages received by the drone 202. In some embodiments, the control circuit 204 determines the trustworthiness of a message based on an analysis of contextual information for the message and an expectation for the message. In such embodiments, the control circuit 204 determines the contextual information for the message based on holistic approach. This holistic approach considers the identity of the source transmitting the message, the content of the message, and observational data.

The sensors 208 detect operational data for the drone 202. The observational data can include information internal to the drone 202 and external to the drone 202, such as the drone's 202 direction of travel, the drone's 202 speed, the drone's 202 altitude, weather conditions, the presence of objects near the drone 202, electromagnetic energy (e.g., radiofrequency signals) near the drone 202, etc. Accordingly, the sensors 208 can be any type of sensor that is suitable to detect the operational data. For example, the sensors can include radar sensors, temperature sensors, time sensors (e.g., a clock), power sensors, sound sensors, reservoir level sensors, weight sensors, location sensors (e.g., GPS transceivers), altitude sensors (e.g., altimeters), gyroscopes, pressure sensors, humidity sensors, moisture sensors, accelerometers, etc. In some embodiments, the operational can be used for navigational purposes.

The wireless radio 210 is configured to receive and transmit messages. Although depicted in FIG. 2 as a single unit (i.e., a transceiver), the wireless radio 210 can comprise a separate transmitter and receiver. The wireless radio 210 can receive and transmit messages via any suitable communication protocol, and in some embodiments, can receive and transmit messages via multiple communication protocols. For example, the wireless radio 210 can receive and transmit messages via a WWAN, Bluetooth, Wi-Fi, near field communication (NFC), radio frequency, etc. Additionally, the wireless radio 210 can receive and transmit messages to any number of devices, such as other drones, backend servers, mobile devices, computing devices, etc.

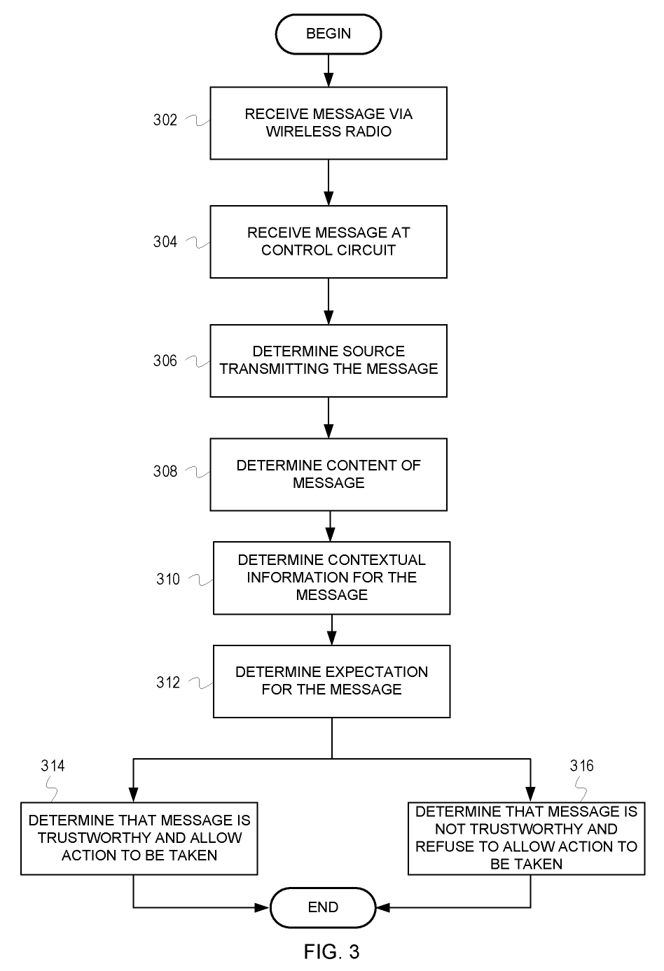

While the discussion of FIG. 2 provides additional detail regarding a drone capable of autonomously determining trustworthiness of messages received by the drone, the discussion of FIG. 3 describes example operations for autonomously determining trustworthiness of messages received by a drone.

FIG. 3 is a flow chart depicting example operations for autonomously determining trustworthiness of a message received by a drone, according to some embodiments. The flow begins at block 302.

At block 302, a message is received via a wireless radio. For example, the wireless radio can be affixed to a drone. The wireless radio is configured to transmit and receive messages for the drone. The flow continues at block 304.

At block 304, the message is received by a control circuit. For example, the control circuit can be communicatively coupled to the wireless radio and receive the message from the wireless radio. The flow continues at block 306.

At block 306, a source transmitting the message is determined. For example, the control circuit can determine the source transmitting the message. The source transmitting the message is the entity that transmitted the message received via the wireless radio. In some embodiments, the message includes identifying information. The identifying information allows the control circuit to determine, explicitly or implicitly, the source transmitting the message. The identifying information can be metadata, a signature, circumstantial data, etc. In some embodiments, the control circuit cryptographically verifies the source transmitting the message. For example, the message can be encrypted via a public/private key system. In such embodiments, the control circuit use the private key to decrypt the message. If the control circuit is able to decrypt the message using the private key, the control circuit can verify the source transmitting the message. In addition to, or in lieu of, the public/private key system, the message can contain historical information for the message in a blockchain format. In such embodiments, the control circuit can review the historical information to verify the source transmitting the message. The flow continues at block 308.

At block 308, content of the message is determined. For example, the control circuit can determine the content of the message. The content of the message can include a type of the message (e.g., informational, instructional, advisory, etc.) and/or the specific information contained in the message (e.g., a specific instruction, a specific notification, etc.). The flow continues at block 310.

At block 310, contextual information for the message is determined. For example, the control circuit can determine the contextual information for the message. In some embodiments, the control circuit considers multiple pieces of data and information when determining the contextual information for the message. For example, the control circuit can consider the source transmitting the message, the content of the message, and observational data when determining the contextual information for the message. The observational data can be detected by, and received at the control circuit, by sensors. The sensors can be local to, and/or remote from, the drone. The flow continues at block 312.

At block 312, an expectation for the message is determined. For example, the control circuit can determine an expectation for the message. In some embodiments, the control circuit determines the expectation for the message based on the contextual information. The expectation for the message can include any suitable factors, such as “is this the type of message I expect to receive from this source,” “is this the type of instruction I expect to receive in this manner,” “is this the way by which I expect to receive a message with this content,” “does this message have an expected impact on my mission,” etc. Put simply, the expectation for the message captures what the drone anticipates receiving based on totality of the circumstances present (i.e., the contextual information for the message). Next, a determination as to the trustworthiness of the message is made. If the message is determined to be trustworthy, the flow continues at block 314. If the message is determined to be untrustworthy (i.e., not trustworthy), the flow continues at block 316.

At block 316, a determination is made as to the trustworthiness of the message. For example, the control circuit can determine that the message is trustworthy. In some embodiments, the control circuit determines that the message is trustworthy based on the contextual information for the message and the expectation for the message. That is, the control circuit determines that the message is trustworthy if the expectation for the message matches the contextual information for the message. If the control circuit determines that the message is trustworthy, the control circuit allows action to be taken by the drone in response to the message.

As previously discussed, if the message is determined to be untrustworthy (i.e., not trustworthy), the flow continues at block 316. At block 316, a determination is made as to the trustworthiness of the message. In some embodiments, the control circuit determines that the message is untrustworthy based on the expectation for the message and the contextual information for the message. That is, the control circuit determines that the message is untrustworthy if the expectation for the message does not match the contextual information for the message. If the control circuit determines that the message is untrustworthy, the control circuit refuses to allow action to be the taken by the drone in response to the message.

In some embodiments, a drone capable of autonomously determining trustworthiness of messages received by the drone comprises a drone body, a propulsion mechanism, wherein the propulsion mechanism is configured to self-propel the drone in a self-controlled manner, a plurality of sensors, wherein the plurality of sensors is configured to detect observational data for the drone, a wireless radio, wherein the wireless radio is configured to receive and transmit messages, and a control circuit, wherein the control circuit is communicatively coupled to the plurality of sensors and the wireless radio, and wherein the control circuit is configured to receive, from the wireless radio, a message, wherein the message includes identifying information regarding a source transmitting the message, determine, based on the identifying information, the source transmitting the message, determine, based on the message, content of the message, determine, based on the source transmitting the message, the content of the message, and the observational data, contextual information for the message, determine, based on the contextual information for the message, an expectation for the message, and one of: determine, based on the contextual information for the message and the expectation for the message, that the message is trustworthy and allow action to be taken by the drone in response to the determination that the message is trustworthy, and determine, based on the contextual information for the message and the expectation for the message, that the message is not trustworthy and refuse to allow action to be taken by the drone in response to the determination that the message is not trustworthy.

In some embodiments, an apparatus, and a corresponding method performed by the apparatus, comprises receiving, via a wireless radio of a drone, a message, wherein the drone comprises a drone body, wherein the drone includes a propulsion mechanism configured to self-propel the drone in a self-controlled manner, and wherein the drone includes a plurality of sensors configured to detect observational data for the drone, receiving, via a control circuit from the wireless radio, the message, wherein the message includes identifying information regarding a source transmitting the message, determining, based on the identifying information, the source transmitting the message, determining, based on the message, the content of the message, determining, based on the source transmitting the message, the content of the message, and the observational data, contextual information for the message, determining, based on the contextual information for the message, an expectation for the message, and one of: determining, based on the contextual information for the message and the expectation for the message, that the message is trustworthy and allowing action to be taken by the drone in response to the determining that the message is trustworthy, and determining, based on the contextual information for the message and the expectation for the message, that the message is not trustworthy and refusing to allow action to be taken by the drone in response to the determining that the message is not trustworthy.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A drone capable of autonomously determining trustworthiness of messages received by the drone, the drone comprising:
a drone body;
a propulsion mechanism, wherein the propulsion mechanism is configured to self-propel the drone in a self-controlled manner;
a plurality of sensors, wherein the plurality of sensors is configured to detect observational data for the drone;
a wireless radio, wherein the wireless radio is configured to receive and transmit messages; and
a control circuit, wherein the control circuit is communicatively coupled to the plurality of sensors and the wireless radio, and wherein the control circuit is configured to:
receive, from the wireless radio, a message, wherein the message includes identifying information regarding a source transmitting the message;
determine, based on the identifying information, the source transmitting the message;
determine, based on the message, content of the message;
determine, based on the source transmitting the message, the content of the message, and the observational data, contextual information for the message;
determine, based on the contextual information for the message, an expectation for the message; and
one of:
determine, based on the contextual information for the message and the expectation for the message, that the message is trustworthy and allow action to be taken by the drone in response to the determination that the message is trustworthy; and
determine, based on the contextual information for the message and the expectation for the message, that the message is not trustworthy and refuse to allow action to be taken by the drone in response to the determination that the message is not trustworthy.

2. The drone of claim 1, wherein the observational data includes one or more of safety, impact on the drone's mission, manner by which the message was sent, external conditions for the drone, internal conditions for the drone, and travel information for the drone.

3. The drone of claim 1, wherein the content of the message is one or more of information, instructions, commands, and advisories.

4. The drone of claim 1, wherein the control circuit is further configured to:
cryptographically verify the source transmitting the message.

5. The drone of claim 1, wherein the expectation for the message is related to one or more of an expected sender, an expected content, a reasonableness of instruction, an expected communication protocol, an expected time, an expected context of the message, expected safety resulting from adherence to the message, and an expected communication.

6. The drone of claim 1, wherein the control circuit is further configured to:
in response to a determination that the message is not trustworthy, flag the source transmitting the message as not trustworthy.

7. The drone of claim 1, wherein the control circuit is further configured to:
generate, in response to receipt of the message, a response; and
cause, via the wireless receiver, the response to be sent to the source transmitting the message.

8. The drone of claim 7, wherein the message is received via a first communication protocol, and wherein the response is transmitted via a second communication protocol.

9. The drone of claim 1, wherein the drone is a leader of a group of drones, wherein the drone receives all messages for members of the group of drones, wherein the drone determines trustworthiness for the messages, and wherein the drone relays the messages to appropriate members of the group of drones.

10. The drone of claim 1, wherein the drone is a leader of a group of drones, wherein each drone in the group of drones transmits messages to the drone, and wherein the drone determines trustworthiness for the messages.

11. A method for autonomously determining trustworthiness of messages received by a drone, the method comprising:
receiving, via a wireless radio of the drone, a message, wherein the drone comprises a drone body, wherein the drone includes a propulsion mechanism configured to self-propel the drone in a self-controlled manner, and wherein the drone includes a plurality of sensors configured to detect observational data for the drone;
receiving, via a control circuit from the wireless radio, the message, wherein the message includes identifying information regarding a source transmitting the message;
determining, based on the identifying information, the source transmitting the message;
determining, based on the message, content of the message;
determining, based on the source transmitting the message, the content of the message, and the observational data, contextual information for the message;
determining, based on the contextual information for the message, an expectation for the message; and
one of:
determining, based on the contextual information for the message and the expectation for the message, that the message is trustworthy and allowing action to be taken by the drone in response to the determining that the message is trustworthy; and
determining, based on the contextual information for the message and the expectation for the message, that the message is not trustworthy and refusing to allow action to be taken by the drone in response to the determining that the message is not trustworthy.

12. The method of claim 11, wherein the observational data includes one or more of safety, impact on the drone's mission, external conditions for the drone, internal conditions for the drone, manner by which the message was sent, and travel information for the drone.

13. The method of claim 11, wherein the content for the message is one or more of information, instructions, commands, and advisories.

14. The method of claim 11, further comprising:
cryptographically verifying the source transmitting the message.

15. The method of claim 11, wherein the expectation for the message is related to one or more of an expected sender, an expected content, an expected context of the message, a reasonableness of instruction, an expected communication protocol, an expected time, expected safety resulting from adherence to the message, and an expected communication.

16. The method of claim 11, further comprising:
in response to determining that the message is not trustworthy, flagging the source transmitting the message as not trustworthy.

17. The method of claim 11, further comprising:
generating, in response to receipt of the message, a response; and
transmitting, via the wireless radio, the response to the source of the message.

18. The method of claim 17, wherein the message is received via first communication protocol, and wherein the response is transmitted via a second communication protocol.

19. The method of claim 11, wherein the drone is a leader of a group of drones, wherein the drone receives all messages for members of the group of drones, wherein the drone determines trustworthiness for the messages, and wherein the drone relays the messages to appropriate members of the group of drones.

20. The method of claim 11, wherein the drone is a leader of a group of drones, wherein each drone in the group of drones transmits messages to the drone, and wherein the drone determines trustworthiness for the messages.
